(19) United States
(12) Patent Application Publication
(10) Pub. No.: US 2001/0051088 A1
(43) Pub. Date: Dec. 13, 2001

(54) Wafer storage equipment and transfer apparatus thereof having a sensor for detecting state of a wafer transfer arm

(76) Inventors: Young Kyou Park, Seoul (KR); Rae Sam Park, Seongnam-city (KR)

Correspondence Address: JONES VOLENTINE, L.L.C., Suite 150, 12200 Sunrise Valley Drive, Reston, VA, 20191, US

(21) Appl. No.: 09/779,471

(22) Filed: Feb. 9, 2001

(30) Foreign Application Priority Data
Jun. 2, 2000 (KR) 2000-30334

(51) Int. Cl. B65G 1/10

(52) U.S. Cl. 414/416.03; 414/416.08; 414/937; 414/941; 118/500; 901/46

(57) ABSTRACT

A wafer transfer apparatus loads and unloads wafers into and from a wafer cassette. The apparatus includes an arm for picking up a wafer, a motor-driven mechanism connected to the arm for moving the arm vertically and horizontally, and a sensor for sensing when the lower surface of the arm contacts an upper surface of a wafer already seated in the wafer cassette. The sensor is made up of a sensor body, a controller, and an amplifier. The arm can be made of metal, in which case the sensor body includes an elastic layer coated on the lower surface of the arm, and an electrically conductive metal layer formed on the elastic layer. When the lower surface of the arm presses against a wafer, the metal layer contacts the metal arm and electrical signals indicative of such contact can thus be produced. Alternatively, the arm may be made of a ceramic. In this case, the sensor body includes a first electrically conductive metal layer disposed on the lower surface of the arm, an elastic layer coated on the first metal layer, and a second electrically conductive metal layer formed on the elastic layer opposite the first metal layer. When the lower surface of the arm presses against a wafer, the metal layers come into contact and electrical signals indicative of such contact can thus be produced.

### BACKGROUND OF THE INVENTION

1. Field of the Invention

The present invention relates to equipment for storing wafers during the manufacture of semiconductor products and to apparatus for transferring the wafers. More particularly, the present invention relates to a wafer transfer apparatus for transferring wafers into and out of a wafer cassette.

2. Description of the Related Art

In the fabrication of semiconductor products, silicon wafers are held in a wafer cassette and are then moved to various processing locations by a wafer transfer apparatus having an arm for picking up and holding the wafers.

FIG. 1 shows conventional wafer storage equipment including a wafer transfer apparatus. Referring to FIG. 1, the conventional wafer transfer apparatus 20 comprises an arm 22 for picking up a wafer 12 and for loading/unloading the wafer 12 into/from a wafer cassette 10, a motor means 26 for vertically and horizontally moving the arm 22, and an elevator 28 for moving the wafer cassette 10 up and down. The up and down movement of the wafer cassette allows the wafers to be loaded/unloaded one after the other into/from designated slots 11 of the wafer cassette 10.

The loading of a wafer by the wafer transfer apparatus 20 will now be described with reference to FIG. 1 to FIG. 3. First, the arm 22, holding a wafer 12a, is moved toward the wafer cassette 10. The wafer 12a is thus placed in its designated slot 11. Once the wafer 12a is placed in the slot 11, the elevator 28 raises the wafer cassette 10 a predetermined distance, whereby the wafer 12a is separated from the arm 22. Alternatively, the motor means 26 may lower the arm 22 to thereby separate the wafer 12a from the arm 22. The operation of unloading the wafer is carried out in the reverse order of the above-described loading operation. Then, the arm 22 is moved away from the cassette 10.

The interval (b) between adjacent slots 11 of the wafer cassette 10 and hence, the distance between wafers 12a and 12b seated in adjacent slots 11, is about 6 mm. The thickness (a) of the terminal end of the arm 22 is about 2 mm to about 3 mm. Therefore, the arm 22 is only free to move up and down relative to the cassette 10 a distance of about 3 mm to about 4 mm. Accordingly, if the arm 22 and/or the elevator 28 are mis-positioned, or if the terminal end of the arm 22 is distorted or abraded to such an extent that it droops, the wafer can be mis-aligned with the designated slot. In this case, the lower surface 24 of the arm 22 at the terminal end of the arm 22 will contact the upper surface of the wafer 12b seated into the slot below the designated slot. Thus, when the arm 22 is moved out of the wafer cassette 10, the upper surface of the wafer 12b is scratched by the lower surface of the arm 22. As a result, the wafers, which are expensive to produce, can be seriously damaged and/or ruined.

### SUMMARY OF THE INVENTION

Accordingly, an object of the present invention is to prevent a wafer from being damaged during a wafer loading or unloading operation.

Another object of the present invention is to provide an indication of when the lower surface of the arm contacts the upper surface of the wafer, whereby such an indication can be used to temporarily stop the arm of the wafer transfer apparatus.

In order to achieve the foregoing objects, the present invention provides an apparatus for transferring wafers, the apparatus comprising an arm for picking up a wafer, a motor-operated driving mechanism connected to the arm for moving the arm vertically and horizontally such that the arm can load/unload a wafer into/from a designated slot of the wafer cassette, and a sensor for sensing the existence of pressure between the lower surface of the arm and an upper surface of a wafer already seated in a respective slot of the wafer cassette.

The arm can be made of metal. In this case, a sensor body of the sensor comprises an elastic layer coated on the lower surface of the arm at a terminal end thereof, and a metal layer made of a conductive metal and formed on the elastic layer. The metal layer is disposed opposite the lower surface of the terminal end of the arm. The sensor will include a controller connected to both the arm and the metal layer. The controller controls the driving of the arm in the wafer transfer apparatus. When the lower surface of the arm contacts the upper surface of a wafer that has already been loaded into the wafer cassette, the metal layer is pressed down by the upper surface of the wafer and thus contacts the lower surface of the arm. Current is thus allowed to flow between the arm and metal layer, whereby signals indicative of the contact between the sensor body and the wafer are produced. When the controller receives such signals, the controller stops the arm from moving until the situation is rectified.

Alternatively, the arm may be made of a ceramic. In this case, the sensor body comprises a first metal layer made of a conductive metal and formed on the lower surface of the terminal end of the arm, an elastic layer coated on the first metal layer, and a second metal layer made of a conductive metal and formed on the elastic layer. The second metal layer is disposed opposite the first metal layer with the elastic layer interposed therebetween. A controller is connected to both the first metal layer and the second metal layer. When the lower surface of the arm contacts the upper surface of a wafer that has already been loaded into the wafer cassette, the second metal layer is pressed down by the upper surface of the wafer and contacts the first metal layer. If this occurs, the controller stops the movement of the arm.

Still further, the sensor body may be provided at another location suitable for causing the sensor body to produce electric signals indicative of pressure existing between the lower surface of the terminal end of the arm and the top of a wafer seated in the wafer cassette.

The sensor of the present invention may also include an amplifier for amplifying the electric signals produced by the sensor body and for transmitting the amplified signals to the controller.

### BRIEF DESCRIPTION OF THE DRAWINGS

These and other objects, features and advantages of the present invention will be readily understood with reference to the following detailed description thereof provided in conjunction with the accompanying drawings, wherein like reference numerals designate like structural elements, and, in which:

FIG. 1 is a perspective view of a conventional wafer transfer apparatus;

FIG. 2 is a schematic diagram showing an arm of the conventional wafer transfer apparatus loading a wafer into a wafer cassette;

FIG. 3 is a schematic diagram showing the arm separating from the wafer;

FIG. 4 is a perspective view of one embodiment of an arm of a wafer transfer apparatus according to the present invention;

FIG. 5 is a schematic diagram showing the arm of the wafer transfer apparatus of FIG. 4 loading a wafer into a wafer cassette;

FIG. 6 is a schematic showing the arm of the wafer transfer apparatus of FIG. 4 as it contacts an upper surface of a wafer;

FIG. 7 is a perspective view of another embodiment of an arm of a wafer transfer apparatus according to the present invention; and

FIG. 8 is a schematic diagram showing the arm of the wafer transfer apparatus of FIG. 7 loading a wafer into a wafer cassette.

### DETAILED DESCRIPTION OF THE PREFERRED EMBODIMENTS

Preferred embodiments of the present invention will now be described with reference to the accompanying drawings.

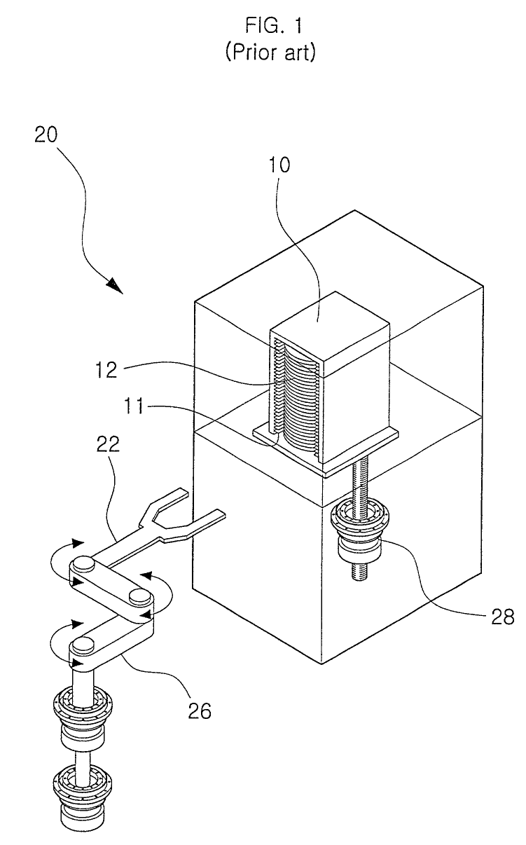

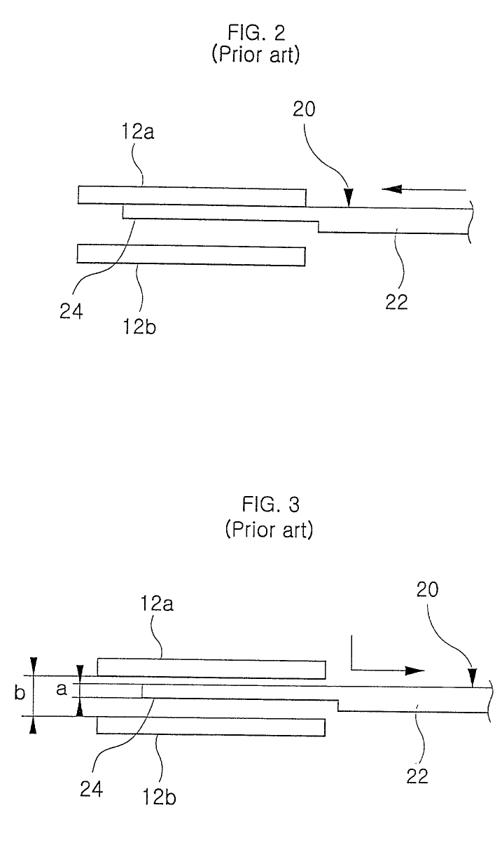

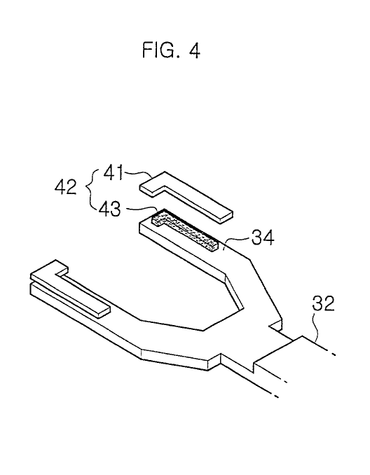

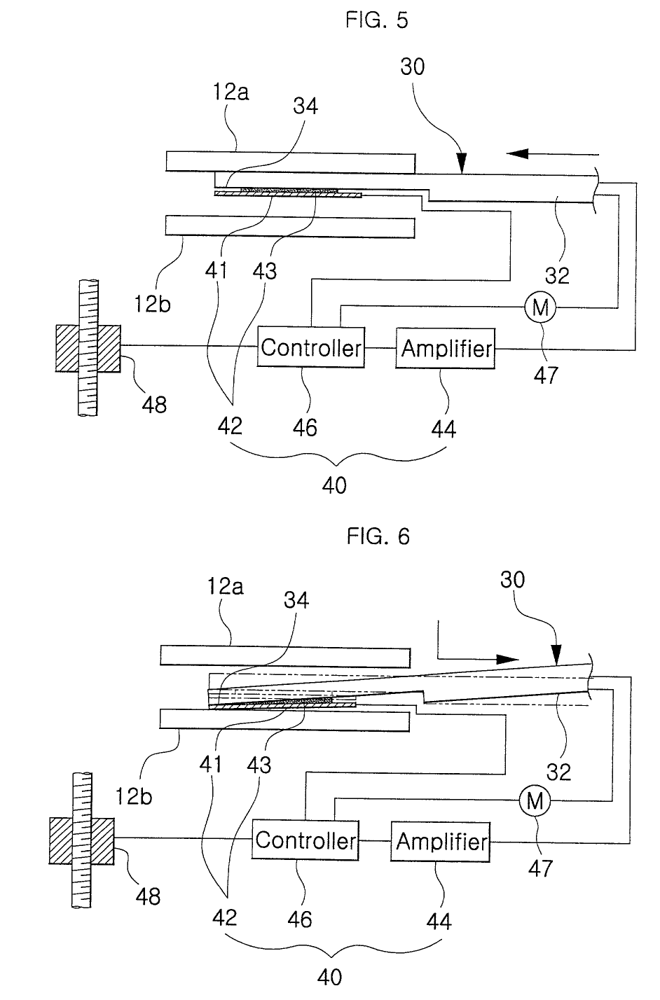

With reference to FIG. 4 to FIG. 6, the wafer transfer apparatus 30 of the present invention comprises an arm 32 for picking up a wafer and then for loading/unloading the wafer into/from a wafer cassette, a drive mechanism 47 for moving the arm 32 vertically and horizontally, and an elevator 48 for moving the wafer cassette vertically. The driving mechanism 47 and elevator 48 can be of the same type used in the conventional wafer transfer apparatus shown in FIG. 1. More specifically, though, the driving mechanism 47 can be any appropriate type, known in the art per se, for moving a mechanical part horizontally and vertically. Likewise, elevators for the wafer cassette are well known in the art, per se, and a detailed description thereof will be omitted for the sake of brevity.

The wafer transfer apparatus 30 further comprises a sensing means 40 for sensing whether the lower surface 34 of the arm 32 is in contact with the upper surface of the wafer 12b. The sensing means 40 is disposed on the lower surface 34 of the arm 3, and thereby senses whether the lower surface 34 of the arm 32 contacts the upper surface of the wafer 12b seated in the wafer cassette. In this embodiment, the sensor 40 is a tactile sensor. The tactile sensor 40 comprises a tactile sensor body 42, an amplifier for amplifying electric signals produced by the sensor body 42, and a controller 46 for receiving the amplified signals and for controlling the wafer transfer apparatus 30 on the basis of the amplified signals. For instance, when the controller 46 receives signals from the sensor 42 indicating that the lower surface 34 of the arm 32 is contacting the upper surface of the wafer 12b, the controller 34 temporarily stops the arm 32 to prevent the wafer from being further damaged. A visual or acoustic alarm system (not shown) may be used to inform a technician of this situation.

As described above in connection with the prior art, the problems that typically occur, e.g., mis-alignment or mechanical defects, can cause the lower surface of the terminal end of the arm to contact the upper surface of a wafer already seated in the wafer cassette. Therefore, the sensor body 42 is disposed on the lower surface of the arm, that is, the surface that is likely to contact a wafer should a problem occur.

In this embodiment, the arm 32 is made of metal. The sensor 42 comprises an elastic layer 43 coated on the lower surface 34 of the terminal end of the arm 32, and a metal layer 41 made of an electrically conductive piece of metal attached to the elastic layer 43. The metal layer 41 is disposed opposite the lower surface 34 of the arm with the elastic layer 43 interposed therebetween.

The controller 46 is connected to both the arm 32 and the metal layer 41, and serves to temporarily stop the arm 32 from moving when the lower surface 34 of the arm 32 contacts the metal layer 41. The thickness of the arm 32 is about 2 mm to about 3 mm. The elastic layer 43 is preferably made of a rubber material, and more preferably, a silicon rubber possessing excellent mechanical stability. The elastic layer 43 is thinner than the metal layer 41. The thickness of the sensor body 42 is about 1 mm to about 1.5 mm considering the thickness of the arm 32 and that the interval between the wafer 12a and the wafer 12b loaded on the wafer cassette is 6 mm.

The amplifier 44 serves to amplify the electric signals produced when the arm 32 and the metal layer 41 contact each other, and to transmit the amplified signals to the controller 46. In this embodiment, because the electric signals are transmitted to the controller 46 through the arm 32, the amplifier 44 is disposed between the arm 32 and the controller 46. Alternatively, if the electric signals are transmitted from the metal layer 41 to the arm 32, the amplifier 44 is disposed between the metal layer 41 and the controller 46.

The operation of the first embodiment of the present invention will now be described in more detail. During the loading or unloading operation, if the lower surface 34 of the arm 32 contacts the upper surface of the wafer 12b, the metal layer 41 on the lower surface 34 of the arm 32 is pressed down by the upper surface of the wafer 12b and thus contacts the lower surface 34 of the arm 32. In this case, the sensor body 42 senses such contact and transmits signals indicative of the contact to the controller 46 through the amplifier 44. As a result, the controller 46 sends a signal to the driving mechanism 47 of the arm 32. This signal acts to temporarily stop the arm 32 from moving. The arm 32 is then separated from the upper surface of the wafer 12b by, for example, driving the cassette downwardly via the elevator. Once the arm 32 is moved off of the wafer 12b completely, the metal layer 41 is restored to its former position due to the resiliency of the elastic layer 43.

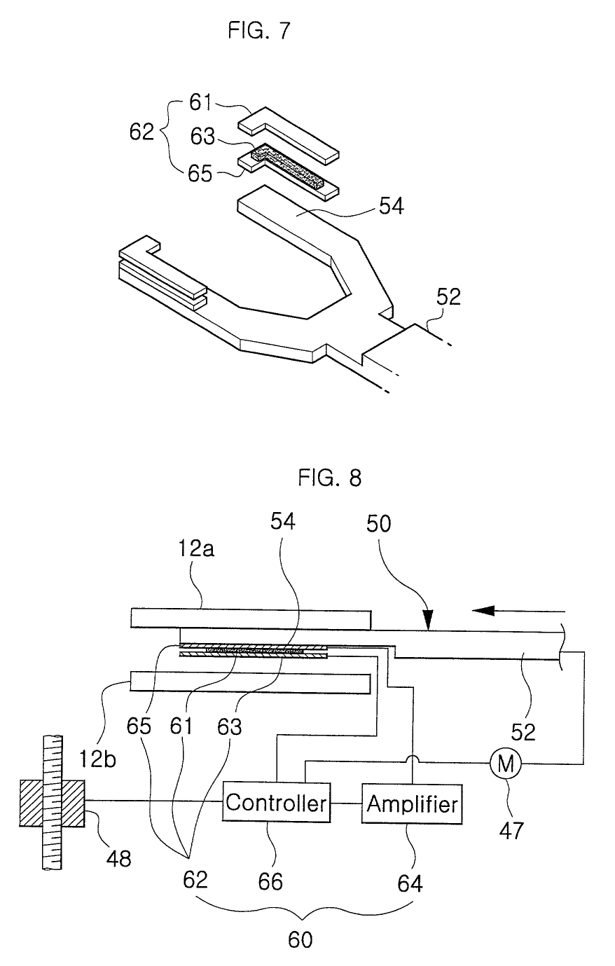

FIGS. 7 and 8 show another embodiment of an arm 52 of a wafer transfer apparatus 50 according to the present invention.

Referring to FIG. 7 and FIG. 8, similar to the first embodiment, the wafer transfer apparatus 50 comprises an arm 52 for picking up a wafer and then for loading/unloading the wafer into/from a wafer cassette, a driving mechanism 47 for vertically and horizontally moving the arm 32, and an elevator 48 for moving the wafer cassette vertically. However, in this embodiment, the arm 52 is made of a ceramic. Furthermore, the wafer transfer apparatus 50 comprises a sensor 60 for sensing whether the lower surface 54 of the arm 52 is in contact with the upper surface of the wafer 12b.

The sensor 60 of the second embodiment also, like the first embodiment, comprises a sensor body 62, an amplifier 64, and a controller 66. However, because the arm 52 is made of a non-conductive material, i.e., a ceramic, the sensor body 62 of the second embodiment differs from that of the first embodiment.

The sensor body 62 comprises a first metal layer 65 made of an electrically conductive metal and disposed on the lower surface 54 of the terminal end of the arm 52, an elastic layer 63 coated on the first metal layer, and a second metal layer 61 made of an electrically conductive metal and disposed on the elastic layer 63. The first metal layer 65 and the second metal layer 61 are disposed opposite to each other with the elastic layer 63 interposed therebetween. The elastic layer 63 is preferably made of a rubber material, and more preferably, a silicon rubber possessing excellent mechanical stability. The interval between the wafer 12a and the wafer 12b seated in the wafer cassette is 6 mm, and the thickness of the arm 52 is about 2 mm to about 3 mm. Therefore, the thickness of the sensor body 62 is about 1 mm to about 1.5 mm and the elastic layer 63 is thinner than the first metal layer 65 and the second metal layer 61.

The controller 66 is connected to both the first metal layer 65 and the second metal layer 61. As in the first embodiment, the controller is programmed to temporarily stop the wafer transfer apparatus 50 when the first metal layer 65 contacts the second metal layer 61.

That is, the amplifier 64 serves to amplify the electric signals produced when the first metal layer 65 contacts the second metal layer 61, and transmits the amplified signals to the controller 66. The amplifier 64 is disposed upstream of the controller 66 in terms of its electrical connection in the apparatus. In the second embodiment of the present invention, the amplifier 64 is disposed between the first metal layer 65 and the controller 66 because electric signals are transmitted from the first metal layer 65 to the controller 66. Alternatively, if electric signals can be transmitted from the second metal layer 61 to the controller 66. In this case, the amplifier 64 is disposed between the second metal layer 61 and the controller 66.

When the arm 52 contacts the upper surface of the wafer 12b during the course of the loading or unloading operation, the wafer transfer apparatus 50 reacts as follows. When the lower surface 54 of the arm 52 contacts the upper surface of the wafer 12b, the second metal layer 61 on the lower surface 54 of the arm 52 is pressed down by the upper surface of the wafer 12b. Thus, the second metal layer 61 will contact the first metal layer 65 at the lower surface 54 of the arm 52. Then, signals indicative of the contact are sent to the controller 66 through the amplifier 64, whereby the controller 66 controls the driving mechanism 47 of the arm 52 to temporarily stop the arm 52 from moving. Then, the arm 52 is separated from the upper surface of the wafer 12b by moving the elevator 48, to which the wafer cassette is mounted, downward. Once the arm 52 is separated from the upper surface of the wafer 12b, the second metal layer 61 is restored to its former position due to the resiliency of the elastic layer 63.

Because the sensor body of the sensor is located on the lower surface of the arm of the wafer transfer apparatus, when the lower surface of the arm is pressed against the upper surface of a wafer already seated in the wafer cassette, the sensor detects such contact. Therefore, the arm can be stopped temporarily to thereby prevent the wafer from being damaged.

Although the present invention has been described in detail hereinabove with respect to the preferred embodiments thereof, many variations and/or modifications thereof will be apparent to those of ordinary skill in the art. For instance, although the sensor body has been described as being disposed on the arm for picking up the wafer and loading/unloading the wafer into/from the wafer cassette, the sensor may be disposed on the wafer cassette itself For instance, a sensor body comprising two electrically conductive layers of metal and an elastic layer interposed therebetween can be provided between the bottom of the wafer cassette and the top of the elevator on which the wafer cassette is mounted. Therefore, all such variations and modifications are seen to fall within the true spirit and scope of the present invention as defined by the appended claims.

What is claimed is:

1. An apparatus for transferring wafers, said apparatus comprising:
an arm having a terminal end configured to pick up a wafer;
a driving mechanism, connected to the arm, and which mechanism moves said arm vertically and horizontally in the apparatus; and
a sensor that senses when said arm presses against the top of an object, said sensor comprising a sensor body mounted to a lower surface of the terminal end of said arm, said sensor body being capable of producing electric signals indicative of contact between the sensor body and an object pressing against the sensor body in a vertical direction.

2. The apparatus as claimed in claim 1, wherein said arm is made of an electrically conductive metal, wherein said sensor body comprises an elastic layer disposed on the lower surface of the terminal end of said arm, and a metal layer of an electrically conductive metal disposed on said elastic layer, said metal layer opposing said lower surface of the terminal end of said arm with the elastic layer being interposed therebetween, and wherein said sensor further comprises a controller operatively electrically connected to both the driving mechanism of said arm and to said metal layer so as to receive the signals produced by said sensor body and so as to control the movement of said arm based on said signals.

3. The apparatus as claimed in claim 1, wherein said arm is made of a ceramic, and wherein said sensor body comprises a first metal layer of an electrically conductive metal disposed on said lower surface of the terminal end of said arm, an elastic layer disposed on said first metal layer, and a second metal layer made of an electrically conductive metal disposed on said elastic layer, said second metal layer opposing said first metal layer with the elastic layer being interposed therebetween, and wherein said sensor further comprises a controller operatively electrically connected to said first metal layer and said second metal layer and to said driving mechanism so as to receive the signals produced by said sensor body and so as to control the movement of said arm based on said signals.

4. The apparatus as claimed in claim 2, wherein said elastic layer is of a silicon rubber.

5. The apparatus as claimed in claim 3, wherein said elastic layer is of a silicon rubber.

6. The apparatus as claimed in claim 2, wherein said sensor further comprises an amplifier operatively electrically connected to said sensor body and to said controller so as to amplify the electric signals produced by said sensor body and transmit the amplified signals to the controller.

7. The apparatus as claimed in claim 3, wherein said sensor further comprises an amplifier operatively electrically connected to said sensor body and to said controller so as to amplify the electric signals produced by said sensor body and transmit the amplified signals to the controller.

8. Wafer storage equipment comprising:
a wafer cassette defining a plurality of slots spaced vertically apart from one another; and
a wafer transfer apparatus for loading and unloading wafers into and out of said wafer cassette, said wafer transfer apparatus including
an elevator atop which said wafer cassette is mounted, for moving the wafer cassette up and down,
an arm having a terminal end configured to pick up a wafer,
a driving mechanism, connected to the arm, and which mechanism moves said arm vertically and horizontally in the apparatus, and
a sensor positioned in the equipment to sense when said arm of the wafer transfer apparatus presses against the top of a wafer already seated in a respective slot of the wafer cassette, said sensor comprising a sensor body capable of producing electric signals indicative of pressure existing between the lower surface of the terminal end of said arm and the top of a wafer seated in the wafer cassette.

9. The equipment as claimed in claim 8, wherein said arm is made of an electrically conductive metal, wherein said sensor body comprises an elastic layer disposed on the lower surface of the terminal end of said arm, and a metal layer of an electrically conductive metal disposed on said elastic layer, said metal layer opposing said lower surface of the terminal end of said arm with the elastic layer being interposed therebetween, and wherein said sensor further comprises a controller operatively electrically connected to both the driving mechanism of said arm and to said metal layer so as to receive the signals produced by said sensor body and so as to control the movement of said arm based on said signals.

10. The equipment as claimed in claim 8, wherein said arm is made of a ceramic, and wherein said sensor body comprises a first metal layer of an electrically conductive metal disposed on said lower surface of the terminal end of said arm, an elastic layer disposed on said first metal layer, and a second metal layer made of an electrically conductive metal disposed on said elastic layer, said second metal layer opposing said first metal layer with the elastic layer being interposed therebetween, and wherein said sensor further comprises a controller operatively electrically connected to said first metal layer and said second metal layer and to said driving mechanism so as to receive the signals produced by said sensor body and so as to control the movement of said arm based on said signals.

11. The equipment as claimed in claim 9, wherein said elastic layer is of a silicon rubber.

12. The equipment as claimed in claim 10, wherein said elastic layer is of a silicon rubber.

13. The equipment as claimed in claim 9, wherein said sensor further comprises an amplifier operatively electrically connected to said sensor body and to said controller so as to amplify the electric signals produced by said sensor body and transmit the amplified signals to the controller.

14. The equipment as claimed in claim 10, wherein said sensor further comprises an amplifier operatively electrically connected to said sensor body and to said controller so as to amplify the electric signals produced by said sensor body and transmit the amplified signals to the controller.

15. The equipment as claimed in claim 8, wherein said sensor body comprises a first metal layer of an electrically conductive metal, an elastic layer disposed on said first metal layer, and a second metal layer made of an electrically conductive metal disposed on said elastic layer, said second metal layer opposing said first metal layer with the elastic layer being interposed therebetween, and wherein said sensor further comprises a controller operatively electrically connected to said first metal layer and said second metal layer and to said driving mechanism so as to receive the signals produced by said sensor body and so as to control the movement of said arm based on said signals.

16. The equipment as claimed in claim 15, wherein said elastic layer is of a silicon rubber.

17. The equipment as claimed in claim 15, wherein said sensor further comprises an amplifier operatively electrically connected to said sensor body and to said controller so as to amplify the electric signals produced by said sensor body and transmit the amplified signals to the controller.
